(19) United States
(12) Patent Application Publication
(10) Pub. No.: US 2017/0187253 A1
(43) Pub. Date: Jun. 29, 2017

(54) Activity accessory with energy harvesting

(71) Applicants: Stephanie Moyerman, Phoenix, AZ (US); Narayan Sundararajan, San Francisco, CA (US)

(72) Inventors: Stephanie Moyerman, Phoenix, AZ (US); Narayan Sundararajan, San Francisco, CA (US)

(21) Appl. No.: 14/757,873

(22) Filed: Dec. 23, 2015

(51) Int. Cl. H02K 1/22; H02K 5/04

(52) U.S. Cl. CPC H02K 1/22; H02K 5/04

(57) ABSTRACT

Apparatus and methods are provided for activity accessory including an energy harvester or generator. In an example, an activity accessory can include a first enclosure and an energy generator enclosed within the first enclosure. The energy generator can include a second enclosure. The energy generator can include a spherical magnet housed within the second enclosure and windings surrounding the second enclosure. Movement of the spherical magnet within the second enclosure can induce charge movement in the windings.

### TECHNICAL FIELD

The disclosure herein relates generally to energy harvesting and more particularly to activity accessories with an energy harvesting device.

### BACKGROUND

Electronics continue to be developed that are smaller yet more powerful computationally and functionally. Opportunities and challenges continue to arise that push the creative enterprise of electronic designers to provide small powerful electronic products that provide desired user functionality in a convenient package. Measurement of certain activity accessories have been carried out to assist athletes or hobbyist better understand an activity and to help the athlete or hobbyist improve their performance in an activity or assist in developing a certain aspect of an activity. Most measurements of the activity accessory is carried out by sensors external to the activity accessory because alternative methods of measurement can interfere with the accessory or the accessories performance during measurement activities.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates generally an example energy harvester or energy generator for an activity accessory.

FIG. 2 illustrates generally a cross-section view of an example activity with an example energy harvester.

FIG. 3 illustrates generally a cross-section view of an example activity with an example energy harvester.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

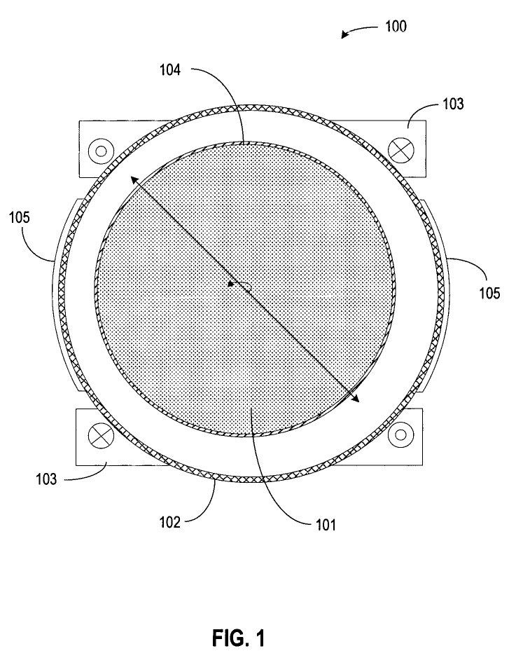

FIG. 1 illustrates generally a cross-section view of an example energy harvesting device 100 for placement in an activity accessory. In certain examples, the energy harvesting device 100 includes a spherical, uniaxially polarized magnet 101, a spherical enclosure 102, and windings 103 placed about the spherical enclosure 102. In certain examples, the magnet 101 can be placed in the hollow interior of the spherical enclosure 102. The spherical enclosure 102 can be counter-wound with coils of wire, the windings 103, at the top and bottom that are connected in series. In certain examples, the spherical enclosure 102 can be designed to be split at the equator such that the magnet can be placed inside and then the two halves of the spherical enclosure 102 can be held together by the windings 103 at the top and bottom.

In certain examples, movement of the spherical magnet 101 can result in an induced current in the windings 103 as predicted by Faraday's law. Movement can include the magnet 101 moving from wall to wall of the spherical enclosure 102 as well as rotational movement of the magnet 101 relative to windings 103. Thus, movement, whether rotational or translational, and in all three dimensions, can result in an induced current in the windings 103 so long as the movement is not perfect rotation about the magnetic moment of the magnet 101. The ability of this design allows the energy harvester 100 to generate maximum electrical energy from activity devices that are not confined to any one dimension of movement. An energy harvesting device 100 according to the present subject matter can be especially advantageous for activity accessories that can often be spinning. Such accessories can include, but are not limited to, balls, pucks or discs. More specific examples of such accessories can include, but are not limited to, cricket balls, soccer balls, baseballs, basket balls, footballs, rugby balls, lacrosse balls, hurling balls, tennis balls, bowling balls, golf balls, golf discs, hockey pucks, etc. IN certain examples, other example activity accessories that can include an example energy harvester and associated electronics can include, but are not limited to, a hockey stick, a cricket bat, a baseball bat, a tennis racket and other activity accessories that a user can handle during a game.

In certain examples, the energy available to be harvested using an example energy harvester 100 can be broadband as the induced current in the windings 103 that result from motion of the example accessories can be at any frequency. In most cases, the accessories listed above can experience a variety of velocities and forces during use, such as during a game. The strike of a bat, for example, to a cricket ball or baseball can carry a very different signature than the release of the ball during a bowl or pitch. An example harvester as shown in FIG. 1, however, can capture energy from each of these motions as well as the different motions induced on the other activity accessories listed above.

In certain examples, the magnet 101 can include a strong rare earth neodymium magnet. In some examples, the magnet 101 can be coated with an elastomer to provide an elastomer coating 104. The elastomer coating 104 can serves two purposes. First, rare earth magnets tend to be quite brittle and over time would probably shatter due to the impact forces sustained by at least some of the activity accessories listed above. In certain examples, the elastomer coating 104 can hold a multiple piece magnet 101 together and can give the spherical magnet 101 a slight cushion, increasing the likelihood that the harvester will last for the lifetime of the activity accessory. Second, the elastomer coating 104 can increase the coefficient of restitution of the magnet, effectively making it “springier” inside of the spherical enclosure 102. Impacts and movements can result in larger, longer, and sharper changes in the position of the magnet, increasing the amount of energy that can be harvested. In some examples, instead of coating the magnet with elastomer, the interior of the spherical enclosure can be coated with elastomer. It is understood that the enclosure for housing the magnet is not limited to a spherical shape and other enclosure shapes are possible without departing from the present subject matter. Such shapes can be described as oblong, oval, egg-shaped or rounded enclosures fashioned from wall segments having a flat surface.

In certain examples, movement of the magnet 101 relative to the windings 103, including rotational movement of the magnet can induce a signal in the windings 103. The alternating-current (AC) signal resultant from the movement of the magnet 101 can be rectified and regulated for use by other electronics 105 that can also be embedded within the activity accessory. In certain examples, rectification can use passive diodes to convert the AC signal to a high-current, low-voltage, direct-current (DC) signal. In certain examples, a buck-boost converter can receive the DC signal to convert it from a high-current, low-voltage signal to a usable voltage source for other electronics integrated with the activity accessory. In certain examples, the power conversion and other electronics can be integrated on flex board in a circuit design that allows the electronics 105 to wrap about the energy harvester 100. In certain examples, placement of particular devices of the electronics 105 can cancel mass offsets associated with the energy harvester 100 such as mass offsets associated with the windings 103 on either end of the harvester 100. In certain examples, the wrapped nature of the electronics 105 about the energy harvester can also facilitate easy connection with leads coming off of the energy harvesting windings 103.

Faraday's law can be used to estimate energy that can be harvested by certain examples of the present subject matter. Faraday's Law states that the induced voltage, or electromagnetic force (EMF), in a wire is equal to the derivative of the magnetic flux in time. In certain examples, the cylindrical magnet can include a N42 neodymium magnet with radius of ¼ inch (″) and surface magnetic field strength of 8815 Gauss. The addition of protective coating, in an example, can increase the radius of the sphere to approximately 70% of the radius of a 1 centimeter (cm) cavity. At the surface of the cavity, since the magnetic field falls off with squared distance, the magnetic field from the ball would be approximately 3756 Gauss=0.3756 Tesla with the assumption that the spherical magnet is perfectly centered.

A spinning magnetic ball, if spinning perpendicular to its axis of magnetization, can be modeled as an electric generator, whose average voltage is given by:

V=BANω/4 (Eq. 1)

where B is the strength of the magnetic field, A is the area of the field, N is the number of coil turns (assumed to be 300), and ω is the rate of rotation in radians/second. The rate of rotation of a bowled cricket ball, as an example, can be anywhere from 800-2600 rpm =84-273 rad/s, yielding an induced voltage of 0.7-2.3 volts. This estimate is based on a best case scenario, where the magnetic ball is rotating exactly perpendicular to the axis of magnetization. Integrating over all possible scenarios yields a multiplicative factor of ¼ (integral of cosine theta from [0,pi]), meaning the true voltage estimate is 0.175-0.57 volts. Assuming the coils have a combined resistance of approximately 5 Ohms, an expected 6-65 milliwatts (mW) of power can be harvested during bowls of an example cricket ball. 6-65 mW of power is plenty of power for some useful electronics that can sense and report conditions associated with the example cricket ball or other activity accessory.

In certain example, an activity accessory can be subject to impacts such as when the example cricket ball is batted, for example. Impacts from the movement of the magnetic ball through the harvester from things like bat strikes and bounces on the field can be modeled. Assuming a modest 3 Hz resonance of the magnetic ball in the cavity when striking a bat or the ground, the magnetic field will change by 8815-3576=5239 Gauss=0.5239 Tesla every 1/12th of a second. Faraday's law then provides a voltage estimate for the 300 coil turns of 0.59 Volts. Again, assuming a resistance of 5 Ohms, an impact or bounce of the example cricket ball can yield a power of 70 mW.

In certain examples, the diameter of the magnet and material of the sphere can be chosen such that they offset the displaced weight from the example cricket ball or other activity accessory while holding the diameter of the spherical shell to roughly 1 cm.

In certain examples, the energy from the energy harvester can be used to power sensors for collecting data about the use of the activity accessory or about the environment in which the activity accessory is used. Such sensors can include, but are not limited to, a temperature sensor, an optical sensor, an accelerometer, a gyroscope. In certain examples, the sensors can provide additional statistical information for the actual judgment during live sports to determine decisions accurately that can affect match outcomes. In addition, it also provides interesting information to spectators, athletes, and coaches, such as the ball spin speed, impact force, drag forces, swing characteristics and exact trajectory tracking. In some examples, the energy of the energy harvester can be used to power a wireless communication transmitter, receiver, or transceiver. Such devices can be used to program the electronics, and for transferring data collected by the electronics. In certain examples, the electronics can include an energy storage device for storing excess energy from the energy harvester and using the excess energy at a later time, such as times when movement of the activity accessory does not allow for generation of enough energy to power the electronics.

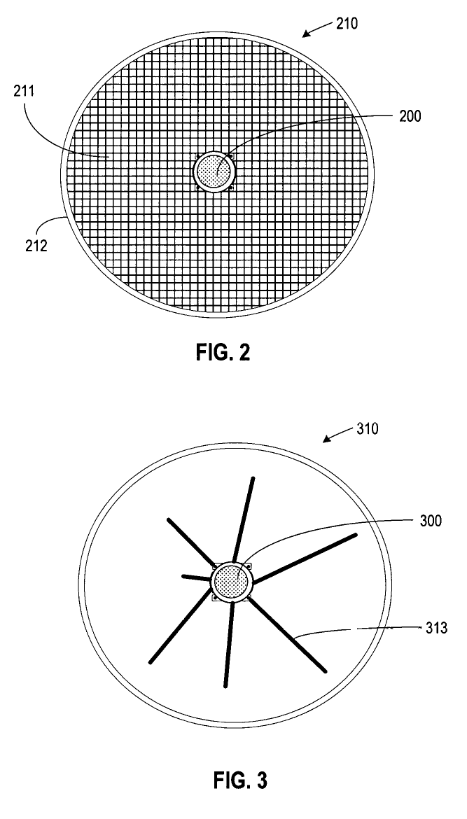

FIG. 2 illustrates generally a cross-section view of an example activity accessory 210 with an example energy harvester 200. The specific activity accessory is a cricket ball which has a substantially solid core 211. The illustrated example is exemplary of other solid activity accessories such as baseballs, pool balls, golf balls, hockey pucks, etc. Such accessories typically include one or more outer layers 212 and a solid core material 211. In certain examples, the energy harvester 200 can be integrated with the core material 211. In some examples, for example a hockey puck, the energy harvester 200 can be molded with the puck material.

FIG. 3 illustrates generally a cross-section view of an example activity accessory 310 with an example energy harvester 300. The specific activity accessory is a soccer ball which is inflatable and is indicative of other inflatable and air core activity accessories. In certain examples, the energy harvester 300 can be suspended within the interior of the activity accessory 310, for example, using strips or cords 313 of elastic material. In some examples, the strips or cords 313 can have an elasticity that allows some give during the most violent impacts the activity accessory 300 is designed to withstand without enough give for the energy harvester 300 to impact a sidewall of the activity accessory 310. In some examples, the energy harvester 300 or energy generator can be integrated or attached to an interior wall of the activity accessory 310.

### ADDITIONAL EXAMPLES AND NOTES

In Example 1, an activity accessory can include a first enclosure and an energy generator enclosed within the first enclosure and including a second enclosure. The energy generator can include a spherical magnet housed within the second enclosure and windings surrounding the spherical enclosure. The three-dimensional movement of the spherical magnet within the second enclosure is configured to induce charge movement in the windings.

In Example 2, the first enclosure of Example 1 optionally is the size and shape of a cricket ball.

In Example 3, the the first enclosure of Example 1 optionally is the size and shape of a baseball.

In Example 4, the first enclosure of Example 1 optionally is the size and shape of a basketball.

In Example 5, the first enclosure of Example 1 optionally is the size and shape of a soccer ball.

In example 6, the first enclosure of Example 1 optionally is the size and shape of a hockey puck.

In Example 7, the first enclosure of Example 1 optionally is the size and shape of a baseball bat.

In Example 8, the spherical magnet of any one or more of Examples 1-7 optionally includes an elastomer coating configured protect the spherical magnet.

In Example 9, the second enclosure of any one or more of Examples 1-8 optionally forms a spherical enclosure.

In Example 10, an elastomer coat optionally covers an interior surface of the spherical enclosure of any one or more of Examples 1-9 to protect the spherical magnet.

In Example 11, the windings of any one or more of Examples 1-10 optionally are configured to translate 3-dimensional or rotation movement of the spherical magnet into electrical energy.

In Example 12, the activity accessory of any one or more of Examples 1-11 optionally includes a plurality of accelerometers to sense motion of the activity accessory, wherein the plurality of accelerometers are powered using energy from the energy generator.

In Example 13, the activity accessory of any one or more of Examples 1-12 optionally includes electronics for using energy collected from the energy generator and/or for collecting data from the plurality of accelerometers, wherein the electronics are positioned adjacent an exterior of the second enclosure.

In Example 14, the activity accessory of any one or more of Examples 1-13 optionally includes a wireless transmitter configure to receive power from the energy generator and to transmit the data.

In Example 15, an activity accessory can include means for harvesting energy from movement of the activity accessory in three dimensions and spinning motion of the activity accessory and means for encapsulating the means for harvesting energy with in the activity accessory.

In Example 16, the activity accessory of any one or more of Examples 1-15 optionally is a cricket ball.

In Example 17, the activity accessory of any one or more of Examples 1-16 optionally is a baseball.

In Example 18, the activity accessory of any one or more of Examples 1-17 optionally is a basketball.

In Example 19, the activity accessory of any one or more of Examples 1-18 optionally is a soccer ball.

In Example 20, the activity accessory of any one or more of Examples 1-19 optionally is a hockey puck.

In Example 21, the activity accessory of any one or more of Examples 1-20 optionally is a baseball bat.

In Example 22, the activity accessory of any one or more of Examples 1-21 optionally includes means to sense motion of the activity accessory, wherein the means to sense motion is powered using energy from the means for harvesting energy.

In Example 23, the activity accessory of any one or more of Examples 1-22 optionally includes a wireless transmitter configure to receive power from the means for harvesting energy.

In Example 24, the first enclosure of any one or more of Examples 1-23 optionally is the size and shape of a sport-related ball.

In Example 25, the first enclosure of any one or more of Examples 1-23 optionally is the size and shape of sports equipment handled by a player during a game.

Each of these non-limiting examples can stand on its own, or can be combined with one or more of the other examples in any permutation or combination.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are legally entitled.

What is claimed is:

1. An activity accessory comprising:
a first enclosure;
an energy generator enclosed within the first enclosure and including a second enclosure, the energy generator comprising:
a spherical magnet housed within the second enclosure; and
windings surrounding the spherical enclosure; and
wherein three-dimensional movement of the spherical magnet within the second enclosure is configured to induce charge movement in the windings.

2. The activity accessory of claim 1, wherein the first enclosure is the size and shape of a sport-related ball.

3. The activity accessory of claim 1, wherein the first enclosure is the size and shape of sports equipment handled by a player during a game.

4. The activity accessory of claim 1, wherein the first enclosure is the size and shape of a hockey puck.

5. The activity accessory of claim 1, wherein the spherical magnet includes an elastomer coating configured protect the spherical magnet.

6. The activity accessory of claim 1, wherein the second enclosure is forms a spherical enclosure.

7. The activity accessory of claim 9, wherein an elastomer coat covers an interior surface of the spherical enclosure to protect the spherical magnet.

8. The activity accessory of claim 1, wherein the windings are configured to translate 3-dimensional movement of the spherical magnet into electrical energy.

9. The activity accessory of claim 1, wherein the windings are configured to translate rotation movement of the spherical magnet into electrical energy.

10. The activity accessory of claim 1, including a plurality of sensors to sense data associated with movement of the activity accessory, wherein the plurality of sensors are powered using energy from the energy generator.

11. The activity accessory of claim 10, wherein the plurality of sensors include an accelerometer to sense motion of the activity accessory.

12. The activity accessory of claim 10, including electronics for collecting the data from the plurality of sensors.

13. The activity accessory of claim 12, wherein the electronics are wrapped about an exterior surface of the energy generator.

14. The activity accessory of claim 12, including a wireless transmitter configure to receive power from the energy generator and to transmit the data.

15. An activity accessory comprising:
means for harvesting energy from movement of the activity accessory in three dimensions and spinning motion of the activity accessory; and
means for encapsulating the means for harvesting energy with in the activity accessory.

16. The activity accessory of claim 15, wherein the means for encapsulating the means for harvesting energy is the size and shape of a sport-related ball.

17. The activity accessory of claim 15, wherein the means for encapsulating the means for harvesting energy is the size and shape of sports equipment handled by a player during a game.

18. The activity accessory of claim 13, including means to sense motion of the activity accessory, wherein the means to sense motion is powered using energy from the means for harvesting energy.

19. The activity accessory of claim 13, including a wireless transmitter configure to receive power from the means for harvesting energy.
